(19) United States
(12) Patent Application Publication
(10) Pub. No.: US 2025/0303807 A1
(43) Pub. Date: Oct. 2, 2025

(54) Ball Mount Roller Device

(71) Applicant: Patrick Rampy, Inyokern, CA (US)

(72) Inventor: Patrick Rampy, Inyokern, CA (US)

(21) Appl. No.: 19/087,649

(22) Filed: Mar. 24, 2025

Related U.S. Application Data
(60) Provisional application No. 63/570,262, filed on Mar. 27, 2024.

(51) Int. Cl. B60D 1/60

(52) U.S. Cl. CPC B60D 1/60

(57) ABSTRACT

A hitch or ball mount roller device designed to prevent trailer hitches, ball mounts, or receivers from dragging on the ground is disclosed. The device comprises a bent metal bar integrated to, or mounted around, the ball mount. A pair of rollers are positioned at the bottom ends of metal bar and extend below the ball mount to prevent ground contact. The rollers are connected via an axle for synchronized rotation. In one embodiment, fastening pins are used to fasten the arms across the top surface of the ball mount tube, preventing lateral displacement of the device along the ball mount. Different embodiments provide flexibility in installation and customization based on the ball mount design, ensuring the ball mount roller device effectively prevents damage to trailer hitches, ball mounts, or receivers by maintaining clearance from the ground during vehicle movement.

### CROSS-REFERENCE TO RELATED APPLICATION

The present application claims priority to, and the benefit of, U.S. Provisional Application No. 63/570,262, which was filed on Mar. 27, 2024, and is incorporated herein by reference in its entirety.

### FIELD OF THE INVENTION

The present invention generally relates to the field of towing equipment. More specifically, the present invention relates to a novel hitch or ball mount roller device designed to prevent trailer hitches, ball mounts, or receivers from dragging on the ground. The hitch or ball mount roller device includes a bent metal bar integrated with the hitch or ball mount, featuring multiple arms that support a pair of rollers. The device can be permanently integrated during manufacturing or temporarily attached using pins and fasteners. Rollers can be removed and replaced when worn out. The assembly does not obstruct hitch or ball mount usage for mounting a trailer ball. Accordingly, the present disclosure makes specific reference thereto. Nonetheless, it is to be appreciated that aspects of the present invention are also equally applicable to other like applications, devices, and methods of manufacture.

### BACKGROUND

By way of background, a trailer hitch or ball mount is a versatile addition to a vehicle that significantly increases its towing and cargo-carrying capabilities. However, a common problem arises when a trailer receiver or a hitch or ball mount attached to the receiver drags on the ground. The contact of the hitch or ball mount with the ground can cause damage to both of the ground surface and the hitch, ball mount, or receiver itself. The constant grinding of the hitch, ball mount, or receiver against pavement or concrete not only deteriorates the ground surface but also wears down the hitch, ball mount, or receiver to the point of becoming ineffective and potentially destroyed. This issue is particularly problematic when the vehicle is in reverse, as the hitch, ball mount, or receiver can dig into asphalt, creating resistance that prevents the vehicle from moving backward. The dragging of the hitch or ball mount reduces the functionality thereof and shortens the life as well. Individuals desire a device that can prevent continuous destructive contact of the hitch or ball mount and receiver with the ground.

Therefore, there exists a long-felt need in the art for an improved hitch or ball mount roller device that effectively prevents trailer hitches, ball mounts, or receivers from dragging on the ground. There is also a long-felt need in the art for a novel hitch or ball mount roller device that protects both of the hitch or ball mount and the ground surface from damage. Additionally, there is a long-felt need in the art for an improved hitch or ball mount roller device that ensures smooth vehicle movement, particularly in reverse, without the hitch, ball mount, or receiver digging into the asphalt. Moreover, there is a long-felt need in the art for a unique hitch or ball mount roller device that is easy to install and can be either permanently integrated or temporarily attached as needed. Further, there is a long-felt need in the art for a hitch or ball mount roller device with replaceable components, such as rollers, to extend the device's lifespan. Furthermore, there is a long-felt need in the art for a hitch or ball mount roller device that does not obstruct the use of the hitch or ball mount for towing purposes. Finally, there is a long-felt need in the art for a hitch or ball mount roller device that combines durability, functionality, and ease of use to provide comprehensive protection for trailer hitches, ball mounts, or receivers.

The subject matter disclosed and claimed herein, in one embodiment thereof, comprises an anti-drag hitch or ball mount roller device. The device includes a bent metal bar welded to a hitch or ball mount, the bar having a plurality of arms, the arms are disposed such that two of the arms form vertical arms on opposite or opposing sides of the hitch or ball mount and a third arm is disposed on top of the hitch or ball mount, a pair of rollers are disposed at the bottom ends of the arms, the rollers are connected via an axle that extends between the rollers and under the hitch or ball mount, enabling synchronized rotation of the rollers on the ground. When the hitch or ball mount is lowered, the rollers touch the ground and roll, thereby preventing contact of the hitch or ball mount to the ground and dragging of the hitch or ball mount.

In this manner, the hitch or ball mount roller device of the present invention accomplishes all of the foregoing objectives and provides users with a novel solution to prevent trailer hitches, ball mounts, or receivers from dragging on the ground. The device features a bent metal bar integrated with a hitch or ball mount, including multiple arms positioned to support a pair of rollers. These rollers are strategically placed below the hitch or ball mount, ensuring that the hitch or ball mount does not contact the ground, thereby protecting both of the hitch or ball mount and the ground surface from damage. The hitch or ball mount roller device also ensures smooth vehicle movement, especially in reverse, by preventing the hitch or ball mount from digging into the asphalt. Additionally, the device is designed for ease of installation, with options for both permanent and temporary attachment. The replaceable rollers extend the lifespan of the device, and its design does not obstruct the use of the hitch or ball mount for towing purposes. The hitch or ball mount roller device combines durability, functionality, and ease of use to provide comprehensive protection for trailer hitches, ball mounts, or receivers.

### SUMMARY OF THE INVENTION

The following presents a simplified summary in order to provide a basic understanding of some aspects of the disclosed innovation. This summary is not an extensive overview, and it is not intended to identify key/critical elements or to delineate the scope thereof. Its sole purpose is to present some general concepts in a simplified form as a prelude to the more detailed description that is presented later.

The subject matter disclosed and claimed herein, in one embodiment thereof, comprises a hitch or ball mount roller device designed to prevent trailer hitches, ball mounts, or receivers from dragging on the ground. The device comprises a bent metal bar integrated to, or mounted around, a hitch or ball mount, the bar having a plurality of arms, a pair of rollers disposed at the bottom ends of the arms, wherein at least a portion of the rollers extend below the hitch or ball mount, the rollers are adapted to touch the ground and roll on the ground when the hitch or ball mount is lowered, thereby preventing the hitch or ball mount from contacting the ground.

In yet another embodiment, an anti-drag hitch or ball mount roller device is disclosed. The device includes a bent metal bar integrated to, or mounted around, a hitch or ball mount, the bar having a plurality of arms, the arms are disposed such that two of the arms form vertical arms on opposite or opposing sides of the hitch or ball mount and a third arm is disposed on top of the hitch or ball mount, a pair of rollers disposed at the bottom ends of the arms, the rollers are connected via an axle that extends between the rollers and under the hitch or ball mount, enabling synchronized rotation of the rollers on the ground.

In another embodiment, a hitch or ball mount roller device designed to prevent trailer hitches, ball mounts, or receivers from dragging on the ground is disclosed. The hitch or ball mount roller device includes a pair of arms positioned on opposite or opposing sides of a hitch or ball mount, each arm having a roller disposed at the bottom end thereof. An axle connects the rollers for synchronized rotation. A first pin member fastens the arms across the top surface of the hitch or ball mount tube, and a second fastening pin is secured near the bottom ends of the arms and prevents lateral displacement of the device along the hitch or ball mount.

In another aspect, the rollers can be removed and replaced when worn out, the top ends of the rollers align horizontally with the hitch or ball mount, and at least a portion of the rollers extend below the hitch or ball mount, and the device does not obstruct the use of the hitch or ball mount for mounting a trailer ball.

Numerous benefits and advantages of this invention will become apparent to those skilled in the art to which it pertains upon reading and understanding of the following detailed specification.

To the accomplishment of the foregoing and related ends, certain illustrative aspects of the disclosed innovation are described herein in connection with the following description and the annexed drawings. These aspects are indicative, however, of but a few of the various ways in which the principles disclosed herein can be employed and are intended to include all such aspects and their equivalents. Other advantages and novel features will become apparent from the following detailed description when considered in conjunction with the drawings.

### BRIEF DESCRIPTION OF THE DRAWINGS

The description refers to provided drawings in which similar reference characters refer to similar parts throughout the different views, and in which:

FIG. 1 illustrates a perspective view of hitch or ball mount roller device of the present invention in accordance with the disclosed structure;

FIG. 2 illustrates a perspective view showing the hitch or ball mount roller device of FIG. 1 installed on a hitch or ball mount in accordance with the disclosed structure;

FIG. 3 illustrates a perspective view of another embodiment of the hitch or ball mount roller device of the present invention in accordance with the disclosed structure; and

FIG. 4 illustrates a perspective view of yet another embodiment of the anti-drag hitch or ball mount roller device of the present invention in accordance with the disclosed structure.

### DETAILED DESCRIPTION OF THE PRESENT INVENTION

The innovation is now described with reference to the drawings, wherein like reference numerals are used to refer to like elements throughout. In the following description, for purposes of explanation, numerous specific details are set forth in order to provide a thorough understanding thereof. It may be evident, however, that the innovation can be practiced without these specific details. In other instances, well-known structures and devices are shown in block diagram form in order to facilitate a description thereof. Various embodiments are discussed hereinafter. It should be noted that the figures are described only to facilitate the description of the embodiments. They are not intended as an exhaustive description of the invention and do not limit the scope of the invention. Additionally, an illustrated embodiment need not have all the aspects or advantages shown. Thus, in other embodiments, any of the features described herein from different embodiments may be combined.

As noted above, there exists a long-felt need in the art for an improved hitch or ball mount roller device that effectively prevents trailer hitches, ball mounts, or receivers from dragging on the ground. There is also a long-felt need in the art for a novel hitch or ball mount roller device that protects both of the hitch or ball mount and the ground surface from damage. Additionally, there is a long-felt need in the art for an improved hitch or ball mount roller device that ensures smooth vehicle movement, particularly in reverse, without the hitch, ball mount, or receiver digging into the asphalt. Moreover, there is a long-felt need in the art for a unique hitch or ball mount roller device that is easy to install and can be either permanently integrated or temporarily attached as needed. Further, there is a long-felt need in the art for a hitch or ball mount roller device with replaceable components, such as rollers, to extend the device's lifespan. Furthermore, there is a long-felt need in the art for a hitch or ball mount roller device that does not obstruct the use of the hitch or ball mount for towing purposes. Finally, there is a long-felt need in the art for a hitch or ball mount roller device that combines durability, functionality, and ease of use to provide comprehensive protection for trailer hitches, ball mounts, or receivers.

The present invention, in one exemplary embodiment, is a hitch or ball mount roller device designed to prevent trailer hitches, ball mounts, or receivers from dragging on the ground is disclosed. The hitch or ball mount roller device includes a pair of arms positioned on opposite or opposing sides of a hitch or ball mount, each arm having a roller disposed at the bottom end thereof. An axle connects the rollers for synchronized rotation. A first pin member fastens the arms across the top surface of the hitch or ball mount tube, and a second fastening pin is secured near the bottom ends of the arms and prevents lateral displacement of the device along the hitch or ball mount.

Reference will now be made in detail to the present preferred embodiments of the invention, examples of which are illustrated in the accompanying drawings. Wherever possible, the same reference numerals are used in the drawings and the description to refer to the same or like parts.

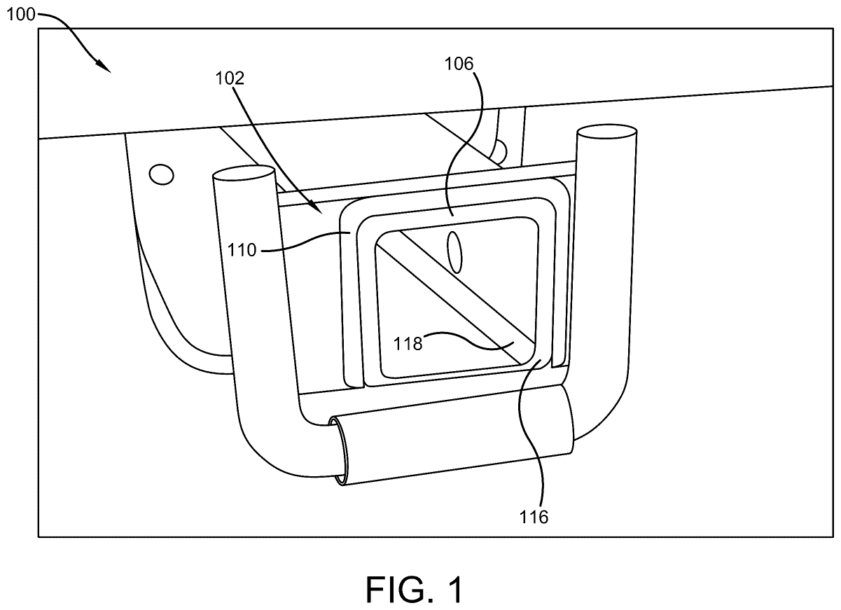

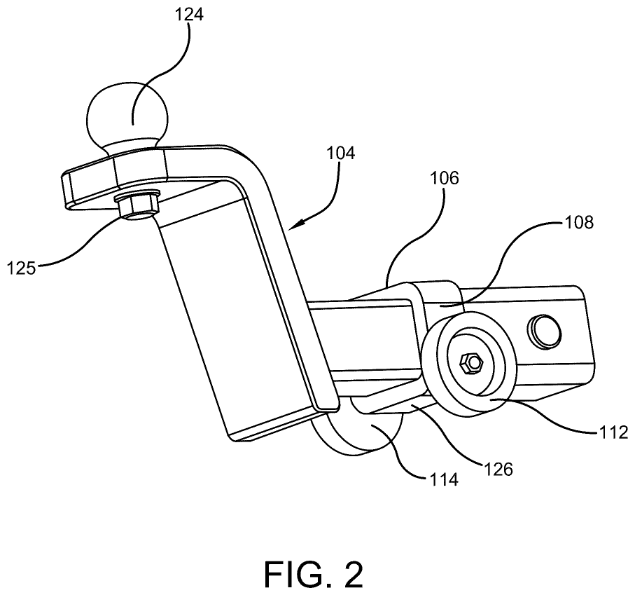

Referring initially to the drawings, FIG. 1 illustrates a perspective view of the hitch or ball mount roller device of the present invention in accordance with the disclosed structure. The hitch or ball mount roller device 100 of the present invention is designed to prevent trailer hitches, ball mounts, or receivers from dragging on the ground, particularly when reversing a vehicle. The trailer hitch or ball mount protection roller assembly 100 helps to avoid damage to the hitch, ball mount, or receiver by ensuring the device rolls against the ground instead of grinding on it. More specifically, the hitch or ball mount roller device 100 of the present embodiment includes a metal bar 102 which is integrated with (i.e., welded to), or mounted around, the hitch or ball mount 104 (FIG. 2). The metal bar 102 is preferably bent and includes a plurality of arms 106, 108, 110 which are integrated to, or mounted around, the hitch or ball mount 104.

Referring now to FIGS. 1 and 2, the metal bar 102 can be integrated to, or mounted around, the hitch or ball mount 104 during manufacturing of the hitch or ball mount 104. The arms 106, 108, 110 are disposed such that the side arms 108, 110 form two vertical arms disposed on opposite or opposing sides of the hitch or ball mount 104 and the top arm 106 is disposed on the top of the hitch or ball mount 104.

A pair of rollers or wheels 112, 114 are disposed at the bottom ends 116, 118 of the arms 108, 110. The pair of rollers or wheels 112, 114 are disposed such that at least a portion (i.e., a bottom portion) of the rollers or wheels 112, 114 extend below the hitch or ball mount 104, thereby preventing the hitch or ball mount 104 from touching the ground and helps in rolling against the ground. Preferably, the top ends 120, 122 of the rollers or wheels 112, 114 align horizontally with the hitch or ball mount 104 and at least a portion of the rollers or wheels 112, 114 extend below the hitch or ball mount 104 and/or below the mounting nut 125 of the trailer ball 124. It should be noted that the hitch or ball mount roller device 100 does not obstruct the use of the hitch or ball mount 104 to hitch or ball mount a trailer. The trailer ball 124 is easily accessible for a mounting point for a trailer coupler. The rollers or wheels 112, 114 are connected via an axle 126 that extends between the rollers or wheels 112, 114 and under the hitch or ball mount 104. The axle 126 enables the rollers or wheels 112, 114 to rotate about the axle 126. The axle 126 is supported by a first receiver 109 mounted to arm 108 and a second receiver 111 mounted to arm 110.

One or both of the rollers or wheels 112, 114 can be removed and replaced when worn out. Further, depending on design and size of the hitch or ball mount 104 and the receiver, the rollers or wheels 112, 114 can be customized and can be positioned at any appropriate position on, or along the neck of, the hitch or ball mount 104.

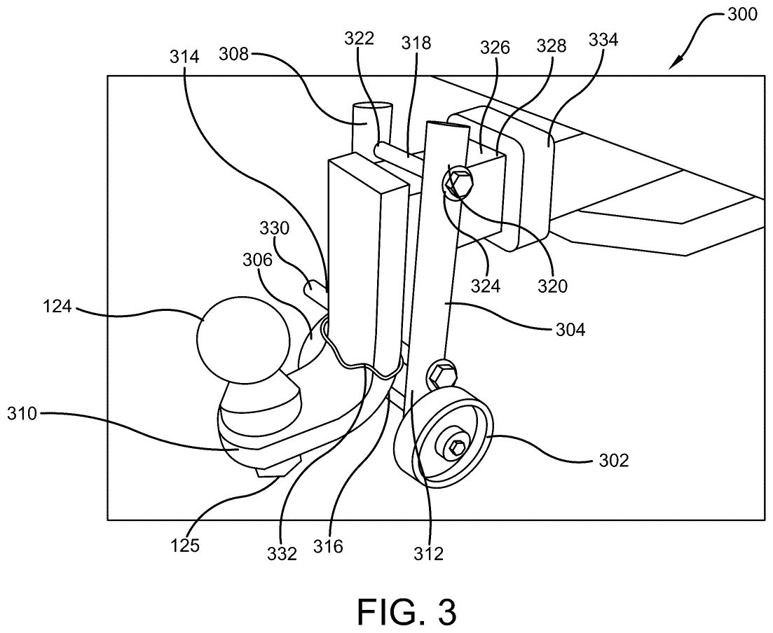

FIG. 3 illustrates a perspective view of another embodiment of the hitch or ball mount roller device of the present invention in accordance with the disclosed structure. In the present embodiment, the anti-drag hitch or ball mount roller device 300 is configured to be temporarily attached to a hitch or ball mount. The hitch or ball mount roller device 300 includes a first roller 302 attached to a first arm 304 and a second roller 306 attached to a second arm 308. The arms 304, 308 are positioned on opposing sides of a hitch or ball mount 310 and extend below the hitch or ball mount 310 and extend below the mounting nut 125 of the trailer ball 124. The first roller 302 is disposed at the bottom end 312 of the first arm 304 and the second roller 306 is disposed at the bottom end 314 of the second arm 308.

An axle 316 connects the rollers 302, 306 for synchronized rotation while the rollers 302, 306 are in contact with the ground. The rollers 302, 306, for example the bottom periphery of rollers 302, 306, extend below the hitch or ball mount 310, thereby preventing the hitch or ball mount 310 from contacting the ground. The device 300 is secured using a first pin member 318 which fastens the arms 304, 308 and passes through the apertures 320, 322 disposed in the arms 304, 308, respectively. The first pin 318 is secured using a washer 324 for a secure fastening. The first pin 318 is disposed across the top surface 328 of the tube 326 of the hitch or ball mount 310. For preventing lateral displacement of the device 300 along the hitch or ball mount 310, a second fastening pin 330 is secured between the apertures disposed near the bottom ends 312, 314 of the arms 304, 308. A metal wire 332 fastens the second fastening pin 330 to the hitch or ball mount 310, thereby preventing the lateral displacement of the device 300. In use, when the hitch or ball mount 310 is lowered, the rollers 302, 306 roll on the ground and prevent the hitch or ball mount 310 from touching the ground and thereby preventing the trailer hitch or ball mount 310 and receiver 334 from dragging on the ground.

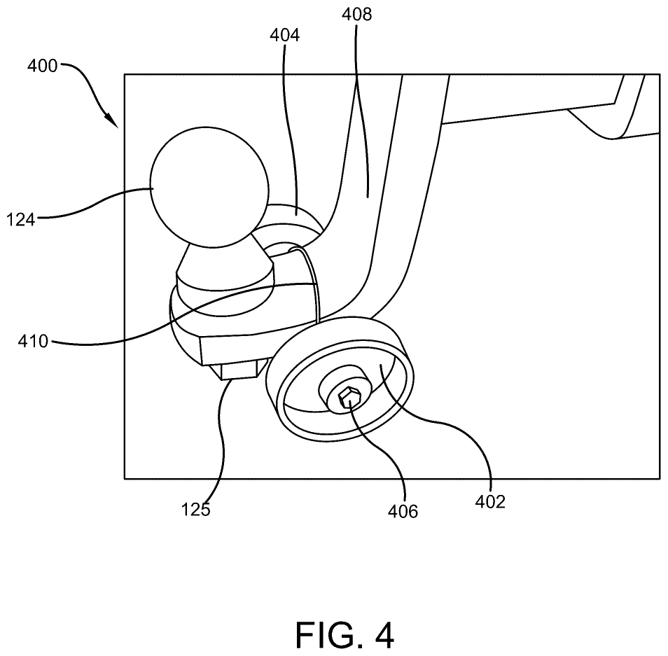

FIG. 4 illustrates a perspective view of yet another embodiment of the anti-drag hitch or ball mount roller device of the present invention in accordance with the disclosed structure. In the present embodiment, the trailer hitch or ball mount protection roller assembly 400 includes a pair of rollers 402, 404 connected via an axle 406. The axle 406 is positioned under the hitch or ball mount 408 and the rollers 402, 404 are disposed below the hitch or ball mount 408. A metal wire 410 is used for pinning the device 400 and fastens the axle 406 to the hitch or ball mount 408. The axis of rotation of the rollers 402, 404 is along the axle 406 and is below the hitch or ball mount 408. The rollers 402, 404 touch the ground first when the hitch or ball mount 408 is lowered such as when reversing a vehicle and therefore prevents the hitch or ball mount 408 from touching the ground.

Certain terms are used throughout the following description and claims to refer to particular features or components. As one skilled in the art will appreciate, different persons may refer to the same feature or component by different names. This document does not intend to distinguish between components or features that differ in name but not structure or function. As used herein “anti-drag hitch or ball mount roller device”, “hitch or ball mount roller device”, “trailer hitch or ball mount protection roller assembly”, and “roller device” are interchangeable and refer to the trailer hitch or ball mount protection roller device 100, 300 of the present invention.

Notwithstanding the forgoing, the trailer hitch or ball mount protection roller device 100, 300 of the present invention can be of any suitable size and configuration as is known in the art without affecting the overall concept of the invention, provided that it accomplishes the above stated objectives. One of ordinary skill in the art will appreciate that the trailer hitch or ball mount protection roller device 100, 300 as shown in the FIGS. are for illustrative purposes only, and that many other sizes and shapes of the trailer hitch or ball mount protection roller device 100, 300 are well within the scope of the present disclosure. Although the dimensions of the trailer hitch or ball mount protection roller device 100, 300 are important design parameters for user convenience, the trailer hitch or ball mount protection roller device 100, 300 may be of any size that ensures optimal performance during use and/or that suits the user's needs and/or preferences.

Various modifications and additions can be made to the exemplary embodiments discussed without departing from the scope of the present invention. While the embodiments described above refer to particular features, the scope of this invention also includes embodiments having different combinations of features and embodiments that do not include all of the described features. Accordingly, the scope of the present invention is intended to embrace all such alternatives, modifications, and variations as fall within the scope of the claims, together with all equivalents thereof.

What has been described above includes examples of the claimed subject matter. It is, of course, not possible to describe every conceivable combination of components or methodologies for purposes of describing the claimed subject matter, but one of ordinary skill in the art may recognize that many further combinations and permutations of the claimed subject matter are possible. Accordingly, the claimed subject matter is intended to embrace all such alterations, modifications and variations that fall within the spirit and scope of the appended claims. Furthermore, to the extent that the term “includes” is used in either the detailed description or the claims, such term is intended to be inclusive in a manner similar to the term “comprising” as “comprising” is interpreted when employed as a transitional word in a claim.

What is claimed is:

1. A vehicle hitch roller device comprising:
a bar;
a plurality of arms;
an axle; and
a pair of rollers;
wherein said bar comprising said plurality of arms;
wherein said plurality of arms having a top arm extending over the ball mount top surface, and a first side arm extending along a first side of the ball mount, and a second side arm extending along a second opposing side of the ball mount;
wherein said pair of rollers having a first roller mounted to a first end of said axle and a second roller mounted to a second end of said axle;
wherein said axle extending under the ball mount and between said first roller and said second roller;
wherein said first side arm having a first receiver and said second side arm having a second receiver; and
further wherein said first receiver and said second receiver supporting said axle.

2. The vehicle hitch roller device of claim 1, wherein said first roller mounted proximal to a bottom end of said first side arm.

3. The vehicle hitch roller device of claim 2, wherein said second roller mounted proximal to a bottom end of said second side arm.

4. The vehicle hitch roller device of claim 3, wherein at least a portion of said first roller extends below the ball mount.

5. The vehicle hitch roller device of claim 4, wherein at least a portion of said second roller extends below the ball mount.

6. The vehicle hitch roller device of claim 3, wherein at least a portion of said first roller extends below a mounting nut of a trailer ball.

7. The vehicle hitch roller device of claim 6, wherein at least a portion of said second roller extends below the mounting nut of the trailer ball.

8. A vehicle hitch roller device comprising:
a bar;
a plurality of arms;
a first fastening pin;
a second fastening pin;
an axle; and
a pair of rollers;
wherein said bar comprising said plurality of arms;
wherein said plurality of arms having said first fastening pin extending over the ball mount top surface, and a first side arm extending along a first side of the ball mount, and a second side arm extending along a second opposing side of the ball mount;
wherein said plurality of arms having said second fastening pin extending between said first side arm and said second side arm;
wherein said second fastening pin proximal to a lower end of said first side arm and a lower end of said second side arm;
wherein said pair of rollers having a first roller mounted to a first end of said axle and a second roller mounted to a second end of said axle;
wherein said axle extending below the ball mount and between said first roller and said second roller; and
further wherein said first side arm and said second side arm having a first pair of aligned apertures for receiving said first fastening pin therethrough.

9. The vehicle hitch roller device of claim 8, wherein said first side arm and said second side arm having a second pair of aligned apertures for receiving said second fastening pin therethrough.

10. The vehicle hitch roller device of claim 9, wherein said first side arm and said second side arm having a third pair of aligned apertures for receiving said axle therethrough.

11. The vehicle hitch roller device of claim 10, wherein said first roller mounted proximal to a bottom end of said first side arm.

12. The vehicle hitch roller device of claim 11, wherein said second roller mounted proximal to a bottom end of said second side arm.

13. The vehicle hitch roller device of claim 12, wherein at least a portion of said first roller extends below the ball mount.

14. The vehicle hitch roller device of claim 13, wherein at least a portion of said second roller extends below the ball mount.

15. The vehicle hitch roller device of claim 12, wherein at least a portion of said first roller extends below a mounting nut of a trailer ball.

16. The vehicle hitch roller device of claim 15, wherein at least a portion of said second roller extends below the mounting nut of the trailer ball.

17. The vehicle hitch roller device of claim 14 further comprising a wire fastener for securing said second fastening pin to the ball mount to prohibit lateral displacement of the vehicle hitch roller device.

18. A vehicle hitch roller device comprising:
a bar;
a plurality of arms;
a first fastening pin;
a second fastening pin;
an axle; and
a pair of rollers;
wherein said bar comprising said plurality of arms;
wherein said plurality of arms having said first fastening pin extending over the ball mount top surface, and a first side arm extending along a first side of the ball mount, and a second side arm extending along a second opposing side of the ball mount;
wherein said plurality of arms having said second fastening pin extending between said first side arm and said second side arm;
wherein said second fastening pin proximal to a lower end of said first side arm and a lower end of said second side arm;
wherein said pair of rollers having a first roller mounted to a first end of said axle and a second roller mounted to a second end of said axle;
wherein said axle extending below the ball mount and between said first roller and said second roller; and
further wherein said first side arm and said second side arm having a first pair of aligned apertures for receiving said first fastening pin therethrough.

19. The vehicle hitch roller device of claim 18 further comprising a wire fastener for securing said second fastening pin to the ball mount to prohibit lateral displacement of the vehicle hitch roller device.

20. The vehicle hitch roller device of claim 19, wherein said first side arm and said second side arm having a second pair of aligned apertures for receiving said second fastening pin therethrough, and further wherein said first side arm and said second side arm having a third pair of aligned apertures for receiving said axle therethrough.
